(19) United States
(12) Patent Application Publication
(10) Pub. No.: US 2004/0108929 A1
(43) Pub. Date: Jun. 10, 2004

(54) Transformer

(75) Inventors: Tomoyuki Ichikawa, Shizuoka (JP); Shinji Ohta, Shizuoka (JP); Takuya Toyama, Shizuoka (JP); Tetsuya Suzuki, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD

(21) Appl. No.: 10/727,567

(22) Filed: Dec. 5, 2003

(30) Foreign Application Priority Data
Dec. 6, 2002 (JP) P. 2002-354912

(51) Int. Cl. H01F 27/02

(52) U.S. Cl. 336/83

(57) ABSTRACT

A transformer comprises a coil portion having a plurality of windings, and a plurality of cores arranged to sandwich the coil portion from aligning directions of the windings, and the windings includes ring-like portions formed by winding a flat-type wire like a ring to overlap each other; both end portions of the flat-type wire are led from the ring-like portions respectively; the plurality of windings and the plurality of cores are arranged along the overlapped direction of the flat-type wire; a projected portion is formed on a first core; the ring-like portions are positioned such that the ring-like portions are fitted on an outer side of the projected portion; a flat surface portion of a second core is positioned to oppose to the projected portion; a gap is formed between the flat surface portion and a top end portion of the projected portion, and the windings are positioned at positions except a position that surrounds the gap.

### BACKGROUND OF THE INVENTION

The present invention relates to a new transformer. More particularly, the present invention relates to the technology capable of achieving a miniaturization by improving electromagnetic coupling between windings to reduce a copper loss (load loss).

As the electric discharge lamp lightening circuit such as a metal halide lamp, etc., the configuration having a DC-DC converter, a DC-AC inverter, and a starting circuit is known. As the control system of the switching power-supply circuit constituting the DC-DC converter, for example, the PWM (Pulse Width Modulation) system or the PFM (Pulse Frequency Modulation) system is known.

Meanwhile, if the fly-back type configuration is employed as the DC-DC converter, the converter transformer is required. In order to reduce the converter transformer in size, the configuration that is suitable for the high-frequency switching control is required. In other words, if en electrical efficiency can be enhanced by switching the transformer at a high frequency, a size of the transformer can be reduced and in turn a size of the overall circuit device can be reduced.

By the way, if the round wire is employed as the winding, such problems existed that, because of the skin effect generated by the higher frequency, increase in the copper loss is caused and also the electromagnetic coupling between the windings becomes difficult.

The skin effect is such a phenomenon that, in case a high-frequency current flows through a conductor, the current can flow through within only a certain limited area under a surface of the conductor and therefore a cross sectional area of the current path is effectively reduced. In the case of the round wire, a substantial volume of the current cannot be sufficiently assured in contrast to a volume of the winding and thus the copper loss is increased.

Also, the transformer having the sandwich arrangement (so-called sandwich winding), normally the coupling in which is believed good, has the configuration in which respective windings are wound sequentially on the cylindrical portion constituting the coil bobbin. In the case of the high-frequency application, the number of turns of the windings is small to reduce the inductance value. As a result, if the round wire is employed, the electromagnetic coupling between the primary windings and the secondary windings becomes worse (This is because the other winding pitch becomes larger than one winding pitch and thus a clearance is generated between both windings)

Therefore, in order to overcome the above problem, the transformer using the windings that are constructed by winding the flat-type wires edgewise has been proposed, as shown in JP-A-2001-126895 (Japanese Patent Application Publication Number: 2001-126895; see FIG. 5 and FIG. 6 thereof).

Since the flat-type wire has a rectangular sectional shape, a sectional area of the wiring can be formed large and thus a resistance value due to the skin effect at a high frequency can be reduced. Also, an unnecessary clearance between respective laminated layers of the flat-type wires becomes small. Thus, such flat-type wire is advantageous to the reduction in size.

Meanwhile, in the conventional art, the problem caused by using the round wire can be overcome with effort by using the windings that are constructed by winding the flat-type wires edgewise, nevertheless it is impossible to improve an efficiency in space much more because of the problem in configuration. As a result, it was difficult to reduce the size of the transformer.

That is, as shown in JP-A-2001-126895, JP-B2-2973514 (Japanese Registered Patent Publication Number: 2973514; see FIG. 2, column 6, lines 39 to 41 thereof) and JP-B2-2791817 (Japanese Registered Patent Publication Number: 2791817; see FIG. 1, FIG. 3, FIG. 26 thereof), the transformer in the conventional arts have the configuration in which the windings are wound around the center magnetic leg of the core and also the gap is positioned at the center of the center magnetic leg. Therefore, there is such a problem that the electromagnetic coupling between the primary winding and the secondary winding is wrong. Also, there is another problem such that the copper loss in the windings that are positioned to surround the gap is considerable.

For example, in the DC-DC converter in the electric discharge lamp lightening circuit of the above metal halide lamp, especially the lightening circuit of the metal halide lamp for the car, the primary current is extremely large rather than the secondary current. Therefore, if the primary winding of the current-split type like NP1, NP2 is employed, as shown in FIG. 17, and the secondary winding NS is sandwiched between two primary windings NP1, NP2, as shown in FIG. 16, the electromagnetic coupling between the primary windings NP1, NP2 and the secondary winding NS can be improved.

In this case, like the above transformer in the prior art, if the gap e is formed between the center magnetic legs c, d of the cores a, b, in the case of the high-frequency application, the number of turns of the winding is set small to reduce the inductance value, as described above, and thus all the secondary winding NS is positioned around the gap e. Therefore, the electromagnetic coupling between the primary windings NP1, NP2 and the secondary winding NS becomes worse and also the copper loss in the secondary winding NS becomes conspicuous.

### SUMMARY OF THE INVENTION

Therefore, it is an object of the present invention to achieve a reduction in size by improving electromagnetic coupling between windings to reduce a copper loss (load loss).

In order to overcome the above problems, a transformer of the present invention comprises a coil portion having a plurality of windings, and a plurality of cores arranged to sandwich the coil portion from aligning directions of the windings, and the windings includes ring-like portions formed by winding a flat-type wire like a ring to overlap each other; both end portions of the flat-type wire are led from the ring-like portions respectively; the plurality of windings and the plurality of cores are arranged along the overlapped direction of the flat-type wire; a projected portion is formed on a first core; the ring-like portions are positioned such that the ring-like portions are fitted on an outer side of the projected portion; a flat surface portion of a second core is positioned to oppose to the projected portion; a gap is formed between the flat surface portion and a top end portion of the projected portion, and the windings are positioned at positions except a position that surrounds the gap.

Therefore, in the transformer of the present invention, since the windings are not positioned at the position that surrounds the gap, the copper loss caused by the influence of the leakage magnetic flux around the gap can be eliminated and the electromagnetic coupling between the primary winding and the secondary winding can be improved.

### BRIEF DESCRIPTION OF THE DRAWING

FIG. 1 is a view showing a configurative example of an electric discharge lamp lightening circuit as an example of a circuit for a transformer according to the present invention.

FIG. 2 is an enlarged view showing a cross section of a flat-type wire.

FIG. 3 is a circuit diagram showing a first embodiment of the present invention.

FIG. 4 is an exploded perspective view showing a first embodiment of the present invention.

FIG. 5 is a longitudinal sectional view showing a first embodiment of the present invention.

FIG. 6 is a longitudinal sectional view showing a second embodiment of the present invention.

FIG. 7 is an exploded perspective view of a core according to a second embodiment of the present invention.

FIG. 8 is an enlarged sectional view of a top end portion of a center magnetic leg according to a second embodiment of the present invention.

FIG. 9 is a graph showing a DC-superposed characteristic of the transformer according to the present invention.

FIG. 10 is a graph showing a DC-superposed characteristic of the transformer in the comparative example.

FIG. 11 is a perspective view showing a variation of a lower core in the second embodiment.

FIG. 12 is a plan view showing an improvement of an arrangement on a wiring substrate for a DC-DC converter that can reduce a stray inductance on the primary side.

FIG. 13 is an exploded perspective view showing a third embodiment of the present invention.

FIG. 14 is a plan view showing a third embodiment of the present invention.

FIG. 15 is a side view showing a third embodiment of the present invention.

FIG. 16 is a longitudinal sectional view showing an example of the transformer in the conventional art.

FIG. 17 a diagram showing a circuit of the transformer shown in FIG. 16.

Note that in the drawings, reference number 10 denotes transformer, 10p1 a primary winding, 10p2 a primary winding, 10p3 a primary winding, 10s1 a secondary winding, 10s2 a secondary winding, 21 a core, 22 a core, 22b an outer leg portion, 22b′ an inner surface (mutually-opposing surface), 22c a center magnetic leg (projected portion), 22c′ an upper end surface (flat surface portion), 23 a gap, 24 a ring-like portion, 24a and 24b a connection terminal (both end portions of a flat-type wire), 25 a ring-like portion, 25a and 25b a connection terminal (both end portions of a flat-type wire), 26a ring-like portion, 26a and 26b a connection terminal (both end portions of a flat-type wire), 27 a ring-like portion, 27a and 27b a connection terminal (both end portions of a flat-type wire), 28 a ring-like portion, 28a and 28b a connection terminal (both end portions of a flat-type wire), 41b a leading terminal (primary side), 42b a leading terminal (primary side), 44b a leading terminal (secondary side), 45b a leading terminal (secondary side), 10Aa transformer, 22A a core, 22d a tapered surface (inclined surface), 22B a core, 46 a center magnetic leg (projected portion), 46a an inclined surface, 46b a flat surface (flat surface portion), 10C a transformer, 20C a coil portion, 52 a ring-like portion, 52a and 52b a connection terminal (both end portions of a flat-type wire), 53 a ring-like portion, 53a and 53b a connection terminal (both end portions of a flat-type wire), 41b a leading terminal (secondary side), 42b a leading terminal (secondary side), 44b a leading terminal (primary side), 45b a leading terminal (primary side)

### DESCRIPTION OF THE PREFERRED EMBODIMENT

Embodiments of a transformer according to the present invention will be explained with reference to the accompanying drawings hereinafter. In this case, the transformer according to the present invention is suitable for the transformer that is used in the DC-DC converter in the lightening circuit of the electric discharge lamp, especially the electric discharge lamp used as a light source of the head lamp of the car, e.g., the metal halide lamp.

An example of such electric discharge lamp lightening circuit of the present invention is shown in FIG. L.

A lightening circuit 1 comprises a DC power supply 2, a DC-DC converter 3, a DC-AC inverter 4, a starting circuit 5, and a control portion 7 for executing lightening control of an electric discharge lamp 6.

The DC-DC converter 3 receives an input voltage from the DC power supply 2 and converts the voltage into a desired DC voltage. In this example, the fly-back type DC-DC converter is employed.

In other words, the DC input voltage that is fed via a lightening switch 8 connected to the positive pole side of the DC power supply 2 is supplied to the primary side of a transformer 10 via an inductor 9. The DC-DC converter 3 is constructed by using a switching element 11 connected to a primary winding 10p of the transformer 10, and a rectifying/smoothing circuit 12 provided to a secondary winding 10s side of the transformer 10.

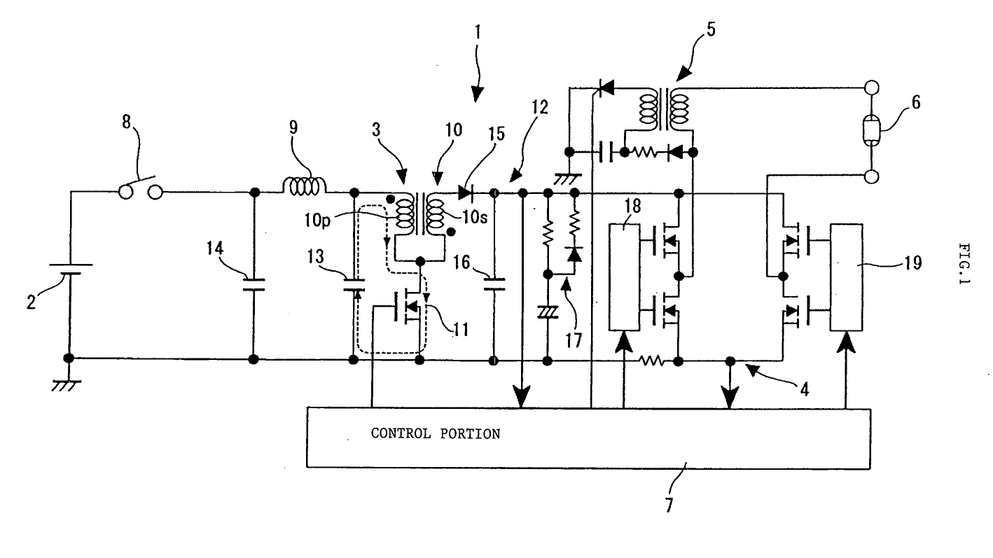

In this case, the present invention is applied to the transformer 10. In FIG. 1, the start of winding in respective windings is shown clearly by marking respective windings 10p, 10s of the transformer 10 with a black dot (the polarity of the winding is shown).

As shown in FIG. 1, the inductor 9 and a capacitor 13 are connected to a start-of-winding side terminal of the primary winding 10p, while one end (terminal on the start-of-winding side) of the secondary winding 10s and the switching element 11 are connected to an end-of-winding side terminal of the primary winding 10p. In this case, a signal fed from the control portion 7 is supplied to the switching element 11. In this example, an N-channel MOSFET (Field Effect Transistor) is employed as the switching element 11 (a drain of the FET is connected to one ends of the windings 10p, 10s, and a source is grounded, and a control signal is supplied to a gate to execute the ON/OFF control).

In this case, one end of a capacitor 14 is connected to a terminal of the inductor 9 on the lightening switch 8 side, and the other end thereof is grounded.

A rectifying diode 15 and a smoothing capacitor 16, which constitute the above rectifying/smoothing circuit 12, are provided to the secondary side of the transformer 10. In other words, the end-of-winding side terminal of the secondary winding 10s of the transformer 10 is connected to an anode of the rectifying diode 15, and a cathode of the rectifying diode 15 is connected to one end of the capacitor 16. Here, the other end of the capacitor 16 is grounded.

A circuit 17 arranged in the subsequent stage of the DC-DC converter 3 is provided to stabilize the lightening state in the initial lightening stage of the electric discharge lamp 6. In this example, this circuit is constructed by a series circuit, which consists of a resistor and a capacitor, and a circuit, which consists of a diode and a resistor and connected in parallel with the resistor of the series circuit.

The DC-AC inverter 4 is provided to convert an output voltage of the DC-DC converter 3 into an AC voltage and then supply the output voltage to the electric discharge lamp 6 via the starting circuit 5.

The starting circuit (so-called starter) 5 is provided to generate a high-voltage pulse signal (starting pulse) for starting the electric discharge lamp 6 and start the electric discharge lamp 6. This signal is superposed on an AC voltage that is output from the DC-AC inverter 4 and applied to the electric discharge lamp 6.

The control portion 7 receives detected signals of the voltage applied to the electric discharge lamp 6 and the current flown through the electric discharge lamp 6 or their equivalent voltage and current, and control a power applied to the electric discharge lamp 6 and also control the output of the DC-DC converter 3. For example, the control portion 7 receives detected signals of the output voltage and current of the DC-DC converter 3, sends out the control signal to the switching element 11 in the DC-DC converter 3 to control the supply capability in response to the state of the electric discharge lamp 6, and controls the output voltage of the DC-DC converter 3 (the PWM system, the PFM system, etc. are known as the switching control system). Also, roles of the control portion 7 are to execute the operation control of the bridge (full bridge in this example) by sending signals to driving circuits 18, 19 of the DC-AC inverter 4, to execute the output control by increasing the supply voltage to the electric discharge lamp up to a certain level before the lightening of the electric discharge lamp to make sure of the lightening of the electric discharge lamp, etc.

Meanwhile, in order to reduce a size of the transformer 10 constituting the DC-DC converter 3, switching control of the switching element 11 at a high frequency (e.g., almost 300 to 500 kHz) is needed. In this case, if the lightening circuit 1 of the electric discharge lamp is employed as the lightning means of the car, it is needed as the noise measure to eliminate the switching frequency from the radio frequency band. For example, in order to take account of the LW band (150 to 280 kHz) and the AM (500 to 1700 kHz) band, the range of 300 to 500 kHz, which is located between both frequency bands, is preferable as the switching frequency band.

When the round wire (a sectional shape is a circular shape) is employed as the winding of the transformer, the problem of reduction in an effective sectional area of the current path due to the skin effect, as described above, still existed. This acts as an increasing cause of the copper loss to lower the electrical efficiency.

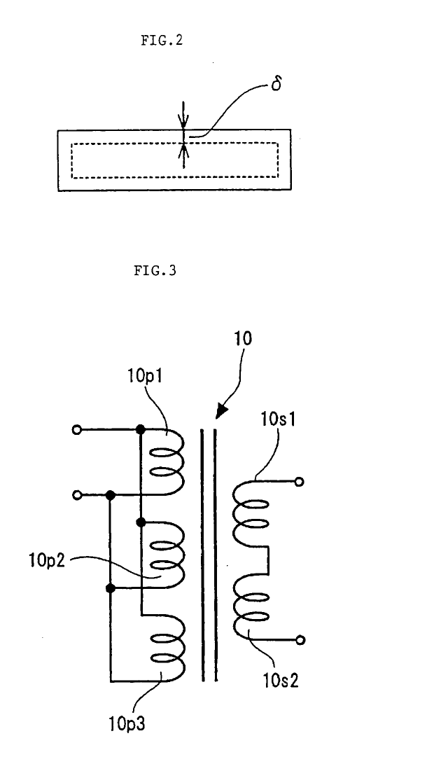

For this reason, in the present invention, the flat-type wire is employed as respective windings of the transformer 10. As shown in FIG. 2, the current flows through the rectangular sectional shape in the range of almost a skin depth δ from an outer surface, but the current seldom flows through the area that is positioned inner than the range (within a rectangular frame indicated by a broken line in FIG. 2). However, an occupied rate of the unavailable area as the current path to the total sectional area is smaller than the case of the round wire.

Also, if the flat-type wire is wound to overlap like a ring, i.e., the edgewise-winding mode is employed, the transformer having a required minimum size can be constructed while suppressing the copper loss. For instance, in the case of the copper wire, since the skin depth δ becomes about 0.1 mm at the frequency of 300 to 500 kHz, the optimum value as a thickness of the flat-type wire is up to about 0.2 mm. As described above, because the number of turns is small in the high-frequency application, a thickness of the overall winding is not so increased.

Now, as one of causes that make the reduction in size of the transformer possible when the flat-type wire is employed, improvement in the space factor is considered. More particularly, because the round wire has a circular sectional shape, unnecessary clearances are generated and also the bobbin is needed in winding the round wire. In contrast, because the flat-type wire has a rectangular sectional shape, ineffective clearances are seldom generated between the windings to enhance a utilization factor of space and also a sectional area of the winding can be increased largely to give the low resistance value.

(First Embodiment)

FIG. 3 to FIG. 5 show a first embodiment of the transformer 10.

In this embodiment, the primary winding of the transformer 10 consists of three primary windings 10p1, 10p2, 10p3, and has a configuration in which respective windings are connected in parallel, i.e., a current-split configuration. Also, the secondary winding has a configuration in which two secondary windings 10s1, 10s2 are connected in series, i.e., a voltage-split configuration.

When the above lightening circuit 1 is employed as a light source (electric discharge lamp) of the lightening tool for the car, for example, the primary current of the transformer 10 in the DC-DC converter 3 is extremely large rather than the secondary current. Therefore, if a structure constructed by dividing the primary winding and the secondary winding into plural portions and then putting the secondary winding between the primary windings is employed, such structure is effective in enhancing the coupling between the primary winding and the secondary winding.

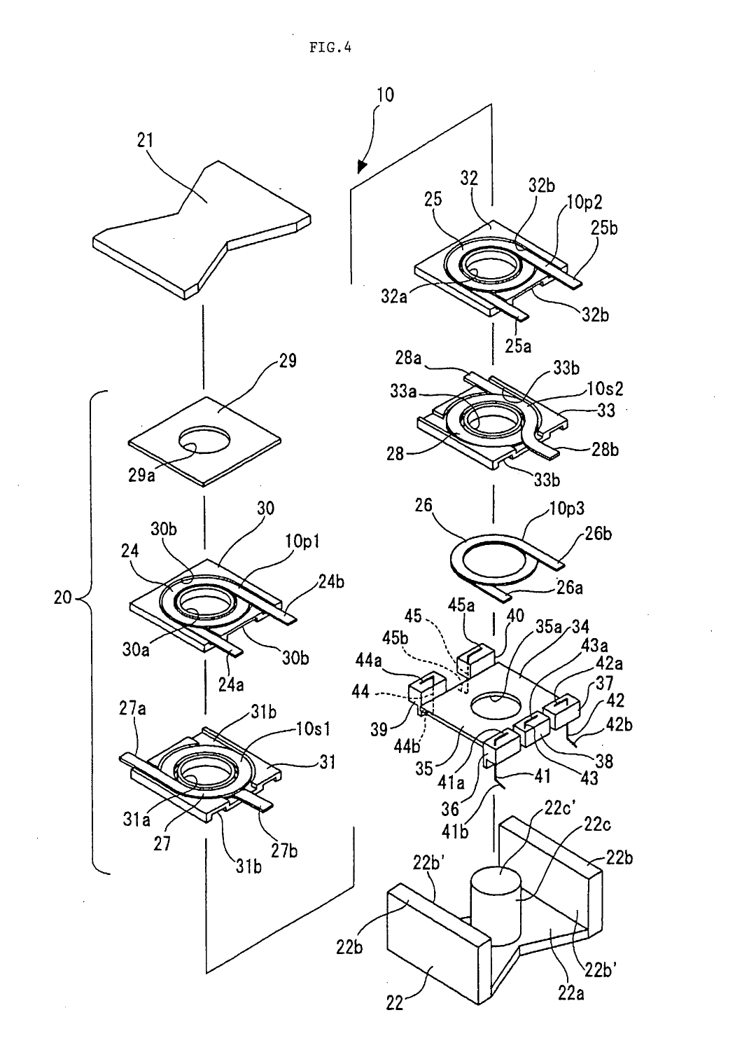

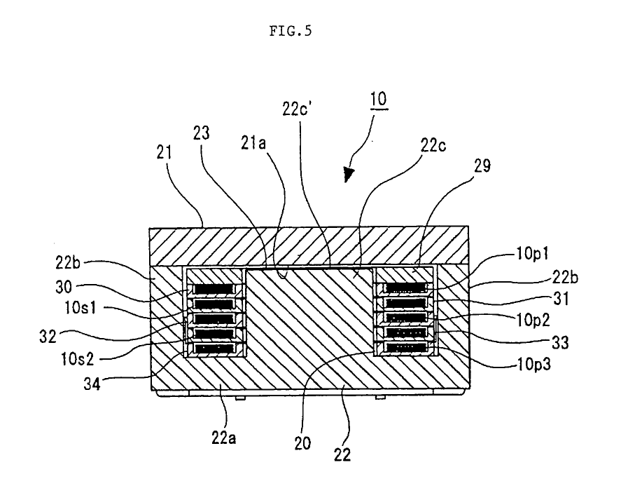

As shown in FIG. 4 and FIG. 5, a coil portion 20 including a plurality of windings (10p1, 10p2, 10p3, 10s1, 10s2) is arranged in the state that such coil portion 20 is put between two cores 21, 22.

The cores 21, 22 are made of a ferrite core, and the upper core 21 is formed like a plate. Also, the lower core 22 is constructed by forming integrally a plate-like lower surface portion 22a, outer leg portions 22b, 22b that are projected upwardly from both ends of the lower surface portion 22a, and a projected portion (center magnetic leg) 22c that is projected upwardly from a center portion of the lower surface portion 22a. Both the core 21 and the lower surface portion 22a of the core 22 have the same shape. In other words, side surfaces are formed like an almost “V” shape in such a manner that such side surfaces along the longitudinal direction of the plate, whose planar shape is a rectangle, are bilaterally symmetrical. Accordingly, the core 21 and the lower surface portion 22a of the core 22 have a constricted part at the center portion.

A length of the center magnetic leg 22c formed in the lower core 22 is slightly shorter than a length of the outer leg portion 22b.

Inner surfaces 22b′, 22b′ of the outer leg portions 22b, 22b of the core 22 are formed as flat surfaces that are mutually parallel.

Then, the coil portion 20 is arranged in a space formed between both cores 21, 22 in the state that two cores 21, 22 are positioned opposite to each other.

The cores 21, 22 are coupled in the state a lower surface of the upper core 21 is brought face to face with upper surfaces of the outer leg portions 22b, 22b of the lower core 22. When two cores 21, 22 are coupled in this manner, an upper end surface 22c′ of the center magnetic leg 22c of the lower core 22 is opposed to a lower surface 21a of the upper core 21 via a slight gap 23. Then, the gap 23 formed between the upper end surface 22c′ of the center magnetic leg 22c of the lower core 22 and the lower surface 21a of the upper core 21 acts as a magnetic gap of the magnetic circuit consisting of two cores 21, 22.

The coil portion 20 is positioned in the state that such coil portion is fitted to the outside of the center magnetic leg 22c.

The coil portion 20 has respective windings using the flat-type wire, and insulating members that are arranged between the windings and between the windings and the cores.

All the windings 10p1, 10p2, 10p3, 10s1, 10s2 are formed as the edgewise winding and have ring-like portions 24, 25, 26, 27, 28, which are formed by winding the flat-type wire like a ring to overlap with each other, and connection terminals 24a, 24b, 25a, 25b, 26a, 26b, 27a, 27b, 28a, 28b, which are extended from these ring-like portions 24, 25, 26, 27, 28, respectively. Then, the connection terminals 24a, 24b, 25a, 25b, 26a, 26b of the primary windings 10p1, 10p2, 10p3 are extended in the same direction. Also, one connection terminals 27a, 28a of the secondary windings 10s1, 10s2 are extended in the opposite direction to the extending direction of the connection terminals of the primary windings in the state that they are separated mutually when viewed from the overlapped direction of the windings, whereas the other connection terminals (middle-point terminals) 27b, 28b are extended in the same direction as the connection terminals of the primary windings in such a manner that such connection terminals 27b, 28b are overlapped with each-other between the connection terminals 24a, 25a, 26a and the connection terminals 24b, 25b, 26b when viewed from the overlapped direction of the windings.

Then, these windings 10p1, 10p2, 10p3, 10s1, 10s2 are arranged such that they are laminated from the top to the bottom in order of 10p1, 10s1, 10p2, 10s2, 10p3. Then, a spacer 29 is positioned between the uppermost primary winding 10p1 and the upper core 21, a spacer 30 is positioned between the primary winding 10p1 and the secondary winding 10s1, a spacer 31 is positioned between the secondary winding 10s1 and the primary winding 10p2, a spacer 32 is positioned between the primary winding 10p2 and the secondary winding 10s2, and a spacer 33 is positioned between the secondary winding 10s2 and the primary winding 10p3. These spacers are all the insulating spacer and have a rectangular-plate shape, and circular through holes 29a, 30a, 31a, 32a, 33a are formed in the spacer respectively. Then, recess portions 30b, 30b, 31b, 31b, 32b, 32b, 33b, 33b for receiving the windings 10p1, 10s1, 10p2, 10s2, 10p3 respectively are formed on both upper and lower surfaces of the spacers 30, 31, 32, 33 that are positioned between the windings. Mutual intervals between respective windings 10p1, 10s1, 10p2, 10s2, 10p3 are made as small as possible by providing these recess portions. Also, a thickness of the spacer 29 is set equal to the above magnetic gap 23 or is set larger than the magnetic gap 23. Accordingly, the winding (10p1) is not positioned at a position corresponding to the magnetic gap 23. As a result, the copper loss generated when the winding (10p1) is positioned to correspond to the magnetic gap 23 can be suppressed.

A pedestal 34 is provided to insulate the lower core 22 and the coil portion 20 and connect respective windings to the circuit, and is formed of insulating material. Three foot portions 36, 37, 38 provided to one end of a rectangular base plate 35 in the longitudinal direction and two foot portions 39, 40 provided to the other end are formed integrally with the pedestal 34. Also, a circular through hole 35a is formed at the center portion of the base plate 35. The above foot portions 36, 37, 38, 39, 40 are projected upward and downward from the base plate 35 respectively, and an amount of downward projection is set slightly larger than a thickness of the lower surface portion 22a of the lower core 22 not to bring a lower surface of the lower surface portion 22a into contact with a printed board (not shown). In this case, an adhesive is interposed between the lower surface of the lower surface portion 22a and the printed board, and the transformer 10 is secured to the printed board with the adhesive. Terminal members 41, 42, 43, 44, 45 are provided to the foot portions 36 to 40 of the pedestal 34 respectively. The terminal members 41 to 45 are formed of conductive wire material, and intermediate portions of the terminal members are buried to pass through vertically the foot portions 36 to 40 and are supported. Portions 41a, 42a, 43a, 44a, 45a that are projected from upper surfaces of these foot portions are bent like an L-shape along upper surfaces of the foot portions 36, 37, 38, 39, 40 respectively to constitute the connection terminals. Also, portions 41b, 42b, 44b, 45b that are projected from lower surfaces of the foot portions 36, 37, 39, 40 of the terminal members 41, 42, 44, 45 are bent outwardly respectively, i.e., portions 41b, 42b and portions 44b, 45b are projected toward the opposite side respectively, to constitute leading terminals. In this case, the terminal members 41, 42 are passed vertically through portions of the foot portions 36, 37, which are located near side surfaces positioned mutually on the opposite side, respectively, whereas the terminal members 44, 45 are passed vertically through portions of the foot portions 39, 40, which are located near side surfaces positioned mutually on the opposite side, respectively. Therefore, an interval between the leading terminals 41b, 42b becomes larger than an interval between the leading terminal 44b, 45b. As a result, the primary-side leading terminal 41b, 42b and the secondary-side leading terminal 44b, 45b can be discriminated simply with the naked eye.

Then, the pedestal 34 is put on the lower core 22 to span the middle constricted portion of the lower core 22. At this time, the center magnetic leg 22c formed in the lower core 22 is inserted into the through hole 35a of the pedestal 34. Then, the primary winding 10p3, the spacer 33, the secondary winding 10s2, the spacer 32, the primary winding 10p2, the spacer 31, the secondary winding 10s1, the spacer 30, the primary winding 10p1, and the spacer 29 are laminated sequentially on the base plate 35 of the pedestal 34. At the end, the connection terminals 24a, 24b, 25a, 25b, 26a, 26b of the primary windings 10p1, 10p2, 10p3 are protruded to the side of the connection ends 41a, 42a of the terminal members 41, 42 provided to the pedestal 34, and then the connection terminals 24a, 25a, 26a are put between the connection end 41a of the terminal member 41 and the upper surface of the foot portion 36 in their laminated state and are clamped temporarily, while the connection terminals 24b, 25b, 26b are put between the connection end 42a of the terminal member 42 and the upper surface of the foot portion 37 in their laminated state and are clamped temporarily. Also, the connection terminals 27b, 28b of the secondary windings 10s1, 10s2 are protruded to the same side as the connection terminals of the primary windings, and the connection terminals 27b, 28b are put between the connection end 43a of the terminal member 43 and the upper surface of the foot portion 38 in their laminated state and are clamped temporarily. In addition, the connection terminal 27a of the secondary winding 10s1 and the connection terminal 28a of the secondary windings 10s2 are protruded to the opposite side to the connection terminals of the primary windings in the state that they are separated from each other when viewed from the overlapped direction of a plurality of windings, and the connection terminal 27a is put between the connection end 44a of the terminal member 44 and the upper surface of the foot portion 39 and is clamped temporarily whereas the connection terminal 28a is put between the connection end 45a of the terminal member 45 and the upper surface of the foot portion 40 and is clamped temporarily. More particularly, initially the connection ends 41a to 45a are extended upwardly straightly, and then such connection ends 41a to 45a are formed into an almost L-shape by bending the connection ends to the upper surface side of the foot portion while putting the connection terminals of the windings on the upper surfaces of the foot portions. In this case, since the inner surfaces 22b′, 22b′ of the outer leg portions 22b, 22b of the core 22 are formed straightly in parallel, the connection terminals 24a, 24b, 25a, 25b, 26a, 26b, 27a, 28a of respective windings 10p1, 10p2, 10p3, 10s1, 10s2 can be taken out to the side direction

In this case, the final connection between the connection terminals and the connection ends is completed by the solder dip, etc., for example.

Lastly, the upper core 21 is put on the spacer 29 and thus the transformer 10 is formed.

In the above transformer 10, since the windings are not positioned at the location that corresponds to the gap 23 of the magnetic circuit, the copper loss in the windings can be suppressed and also the electromagnetic coupling between the primary windings 10p1, 10p2, 10p3 and the secondary windings 10s1, 10s2 can be improved. As a result, this transformer 10 becomes suitable for the transformer that is used in the DC-DC converter of the electric discharge lamp lightening circuit.

Also, since respective windings 10p1, 10p2, 10p3, 10s1, 10s2 are formed by winding edgewise the flat-type wire, the electrical efficiency can be improved and therefore the transformer 10 can be reduced in size.

(Second Embodiment)

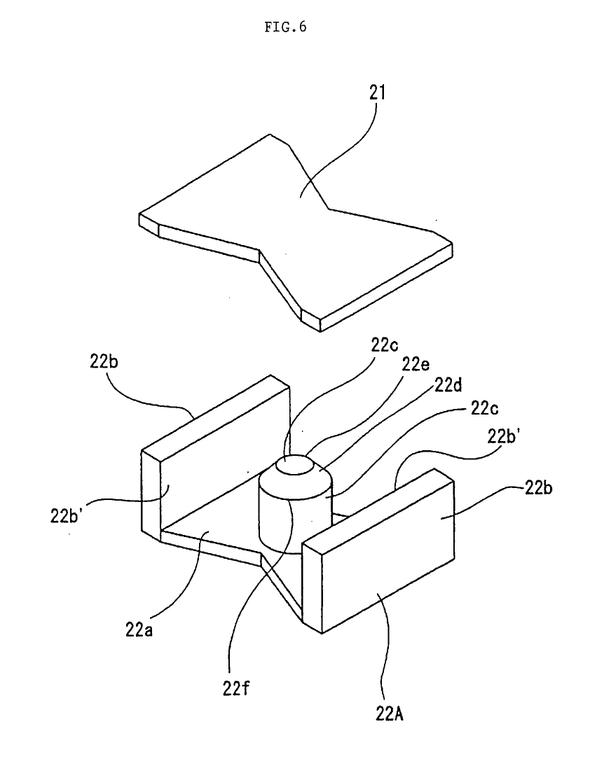

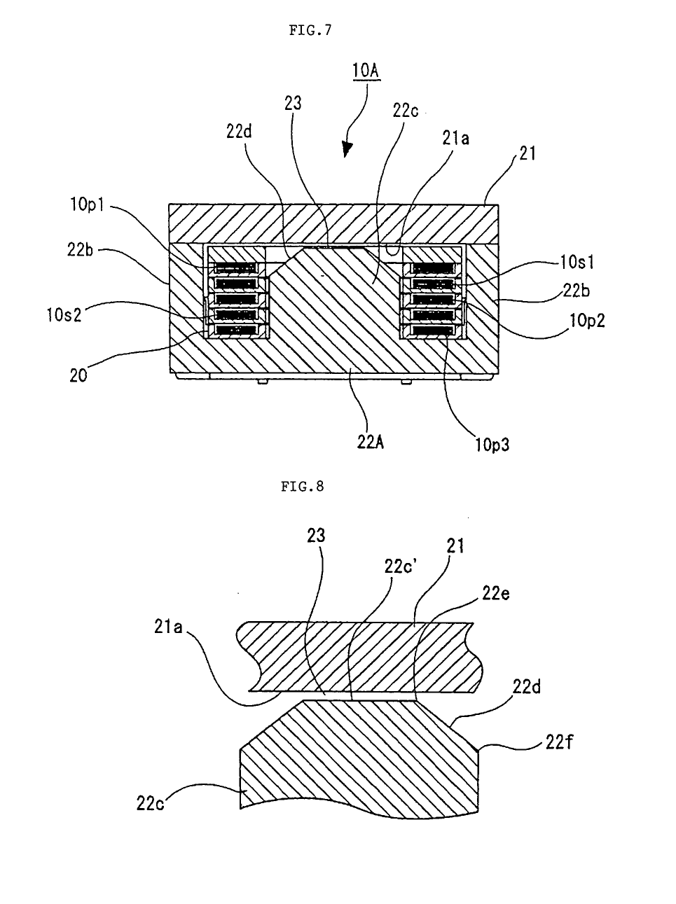

A second embodiment of a transformer of the present invention is shown in FIG. 6 to FIG. 8. In this case, a difference of the second embodiment from the above first embodiment is only a shape of a tope end portion of the center magnetic leg 22c formed in the lower core 22, and remaining portions are similar to those in the first embodiment. Therefore, only different portion will be explained in detail, and illustration and/or explanation of remaining portions will be omitted herein. In the shown case, the same symbols as those affixed to the like portions in the first embodiment are affixed to the same portions as those in the first embodiment.

In this transformer 10A, a tapered surface 22d is formed on the top end portion of the center magnetic leg 22c of a lower core 22A such that the top end portion is tapered off. According to this, a sectional area of the top end portion becomes small gradually toward a top end surface. Then, when two cores 21, 22A are vertically coupled, a gap 23A is formed between the lower surface of the upper core 21 and the upper end surface 22c′ of the center magnetic leg 22c.

In the transformer 10A according to the second embodiment, since the tapered surface 22d is provided to the top end portion of the center magnetic leg 22c, the DC-superposed characteristic becomes preferable as the transformer that is used in the lightening circuit of the electric discharge lamp.

The electric discharge lamp needs a large power in the state that the impedance is low immediately after the starting, while the impedance becomes high and the supply power becomes small in the state that the electric discharge lamp is started completely and the load is stabilized. Therefore, an efficiency at the time of stable load must be enhanced immediately after the starting while preventing the magnetic saturation of the transformer.

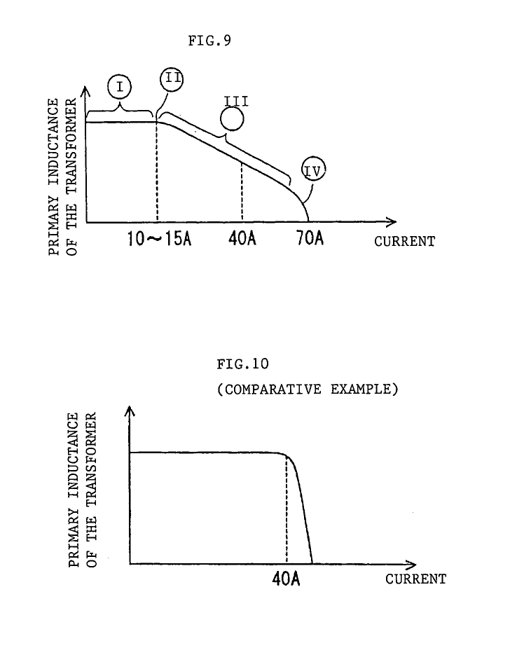

The DC-superposed characteristic of the transformer 10A is shown in FIG. 9. FIG. 9 and FIG. 10 are a graph that has a current on the primary side on an abscissa and the primary inductance of the transformer on an ordinate to show a correlation therebetween respectively.

In the transformer having the gap that is formed by opposing the flat surface mutually, as shown in FIG. 10, there was such a problem that the magnetic saturation is generated abruptly from around 40 A (ampere) to around 50 A and thus it is impossible to expect the stable starting operation.

In contrast, in the above transformer 10A, as can be seen from FIG. 9, the sufficiently-high primary inductance is exhibited in the range (range of “I”) up to about 10 to 15 A (ampere) (position of “II”), and then the primary inductance is reduced gently in the range from “II” to about 70 A (position of “IV”) at which the magnetic saturation is generated abruptly (range of “III”). Therefore, the transformer 10A can fulfill its function sufficiently not to generate the magnetic saturation even immediately after the starting condition where the current that is in excess of 40 A is used.

Next, dimensional precision of respective parts of the top end portion of the center magnetic leg 22c will be explained with reference to FIG. 8 hereunder. Since an interval between the upper end surface 22c′ of the center magnetic leg 22c and the upper core 21 decides the inductance in the above range “I”, these portions call for a high precision. Therefore, a difference between the length of the center magnetic leg 22c and lengths of the outer leg portions 22b, 22b must be defined precisely in those portions. A boundary portion 22e between the upper end surface 22c′ and the tapered surface 22d defines a boundary point of “II”. Thus, since merely the boundary point “II” may be set to exceed a peak current in the stable operation, a high precision is not required of this portion. In contrast, the tapered surface 22d defines an inclination of the range of “III”. Thus, since this range “III” is used in the warm-up operation immediately after the starting, merely the inductance of more than a certain value may be needed in such range and thus a high precision is not required of this portion. A lower end 22f of the tapered surface 22d defines the above position “IV”, and the portion “IV” is a point at which the core is saturated finally. However, since the inductance is reduced gradually in the range “III”, it is supposed that this portion has the very large current value in comparison with the practical range, and therefore a high precision is not required of this portion 22f.

The above lower core 22A is formed by molding the core including the tapered surface 22d by virtue of the mold and then sintering the core. Then, the upper end surface 22c′ of the center magnetic leg 22c is formed with high precision by the cutting in such a way that the gap 23 can constitute a desired interval. According to such manufacture, as described above, the upper end surface 22c′ of the center magnetic leg 22c, which calls for a high precision in formation, can be formed with high precision, whereas the portions that do not call for a high precision in formation, i.e., the inclination of the tapered surface 22d, the positions of the portions 22e, 22f, etc. are formed by the molding using the mold and the sintering as they are. As a result, the balance between the cost and the precision can be attained, and the core 22A can be formed at a low cost.

(Variation of the Second Embodiment)

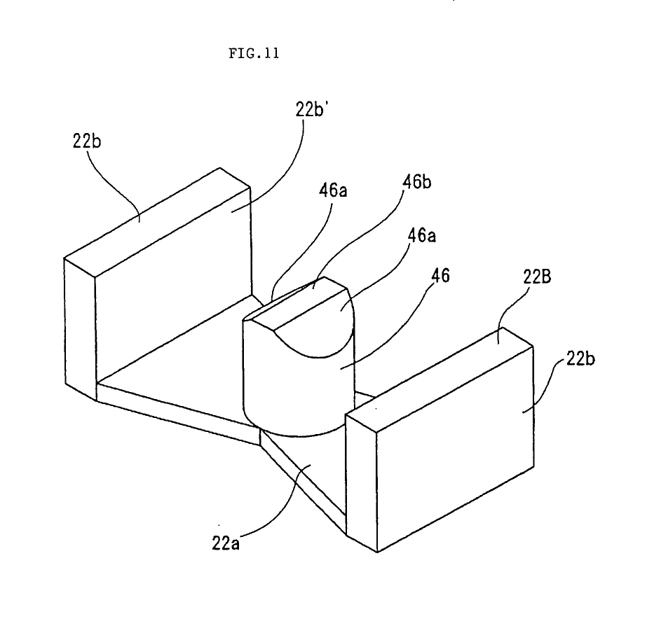

FIG. 11 shows a variation of the lower core (having the center magnetic leg) in the second embodiment.

A lower core 22B is identical to the above core 22A except the top end shape of the center magnetic leg. Therefore, the same symbols as those attached to the like portions in the above core 22A are affixed to the like portions in the core 22A, and their explanation will be omitted herein.

A center magnetic leg 46 of the core 22B is formed like a circular cylinder, and two inclined surfaces 46a, 46a that are positioned on the opposite side mutually are formed on its upper end portion. A stripe-like flat surface 46b is formed between top ends of these inclined surfaces 46a, 46a. The inclined surfaces 46a, 46a are formed to be aligned along the aligning direction of the outer leg portions 22b, 22b, and have an inclination that is displaced to the outer leg portions 22b, 22b side downwardly to the lower surface portion 22a side respectively.

The magnetic circuit is formed by coupling the above lower core 22B and the core, which is similar to the upper core 21 used in the first and second embodiments, vertically. Then, the transformer is constructed by arranging the coil portion 20, which is similar to the coil portion used in the first and second embodiments, in the space formed between the upper and lower cores.

Then, in the transformer using the above core 22B, like the transformer 10A according to the second embodiment, the DC-superposed characteristic also becomes suitable for the transformer employed in the DC-DC converter of the electric discharge lamp lightening circuit.

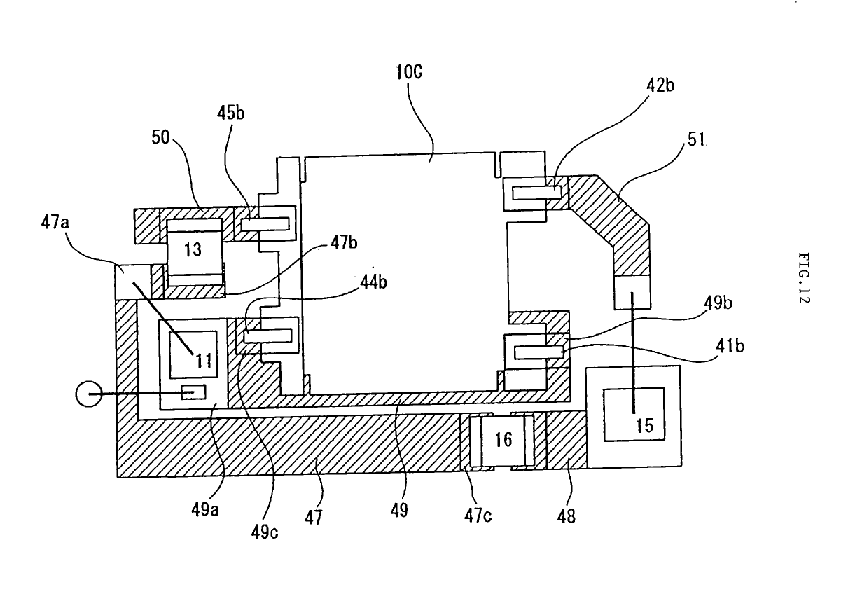

In this case, if the DC-DC converter is switched at a high speed, the inductance of the transformer becomes small (the primary inductance is 1 to 2 pH when the switching frequency is 500 kHz). Since the primary inductance becomes minute in this manner, a path indicated by a broken-line arrow in FIG. 1 must be reduced as short as possible. If this path is long, an energy transfer efficiency from the primary side to the secondary side in the transformer 10 is lowered by the stray inductance caused due to the wirings. An example of arrangement on the wiring substrate, which is considered as the measure, is shown in FIG. 12.

In FIG. 12, the substrate is not shown and only wiring conductors and electronic parts are shown. The wiring conductors are indicated by the hatching, and five wiring conductors 47, 48, 49, 50, 51 are provided in all. The wiring conductor 47 is formed like an almost L-shape to connect the capacitor 13 and the capacitor 16, and has a terminal portion 47a, to which the source of the switching element 11 is connected, near the connection terminal to the capacitor 13. Then, the capacitor 13 is connected to a terminal portion 47b that is formed adjacently on the right side of the terminal portion 47a. The capacitor 16 is connected to a terminal portion 47c that is formed on a right end of a laterally-extended portion of the wiring conductor 47. The wiring conductor 48 for connecting the capacitor 16 and a cathode of the diode 15 is arranged next to the right side of the laterally-extended portion of the wiring conductor 47. The wiring conductor 49 for connecting one leading terminal of the primary winding 10p and one leading terminal of the secondary winding 10s with the drain of the switching element 11 is arranged directly over the laterally-extended portion of the wiring conductor 47 and the wiring conductor 48 so as to extend laterally. The drain of the switching element 11 is connected to a terminal portion 49a on the left end. One leading terminal of the secondary winding 10s is connected to a terminal portion 49b on the right end. One leading terminal of the primary winding 10p is connected to a terminal portion 49c that is formed on the right side of the terminal portion 49a. The wiring conductor 50 that extends shortly in the lateral direction is arranged just over the vertically-extended portion of the wiring conductor 47. The capacitor 13 and the other leading terminal of the primary winding 10p are connected by the wiring conductor 50. The wiring conductor 51 that is right-downward inclined is arranged almost over the right end of the wiring conductor 49. The other leading terminal of the secondary winding 10s and the anode of the diode 15 are connected by the wiring conductor 51.

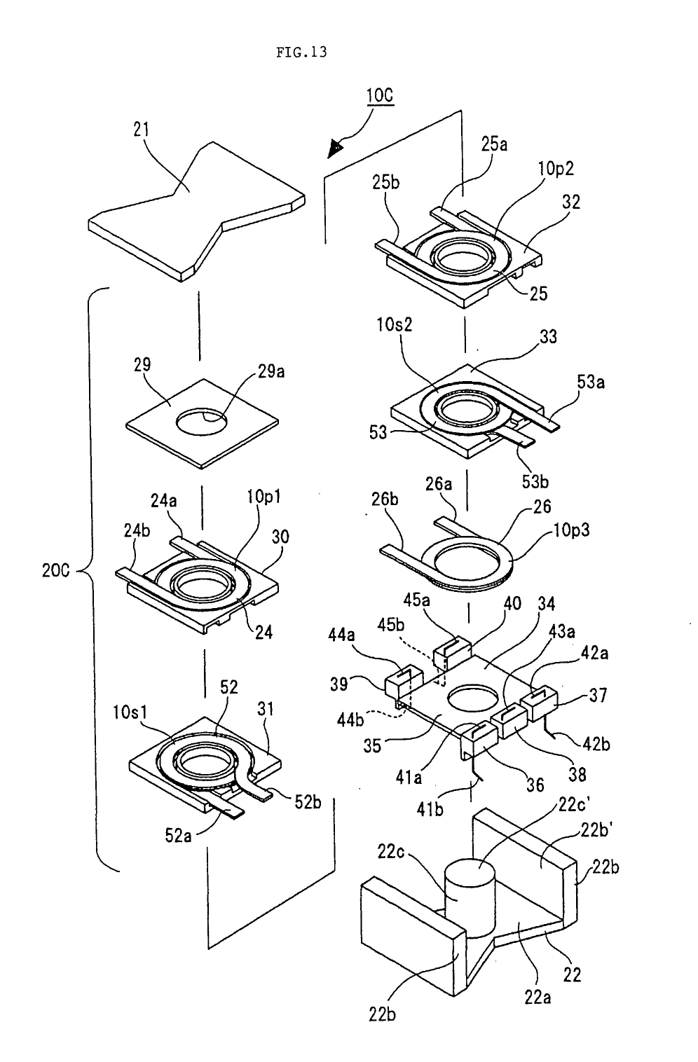

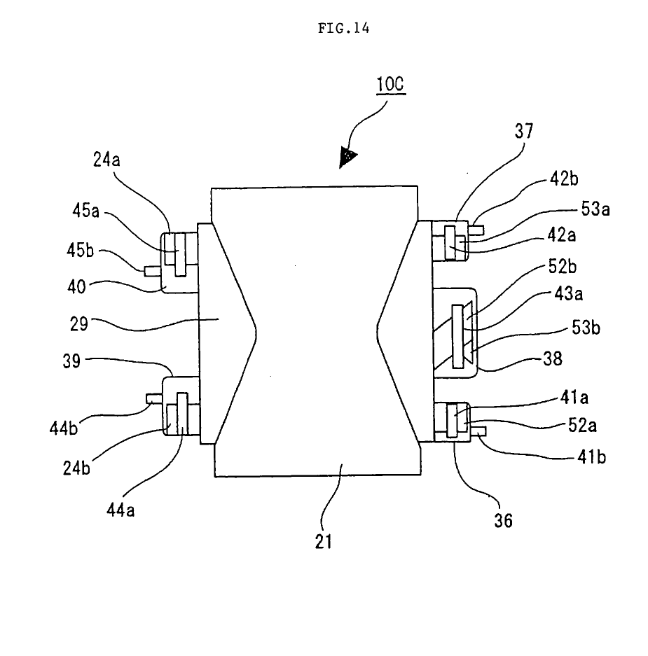

According to the arrangement shown in FIG. 12, the path indicated by the broken-line arrow in FIG. 1 can be constructed shortly and thus the stray inductance caused due to the wirings of the path can be reduced. For this reason, it is important that the interval between the leading terminals of the primary windings 10p in the transformer 10 should be reduced small. A transformer 10C in which the leading terminals are formed in such fashion is shown in FIG. 13 to FIG. 15 as a third embodiment.

(Third Embodiment)

The transformer 10C according to the third embodiment is characterized in that a shape of the secondary winding in the transformer according to the first embodiment is changed and that the leading direction of the connection terminals 24a, 24b, 25a, 25b, 26a, 26b of the primary windings 10p1, 10p2, 10p3 is opposed. Since other configurations are identical to those of the transformer according to the first embodiment, mainly portions about above different points will be explained and explanation of other portions will be omitted herein.

The secondary windings 10s1, 10s2 of the transformer 10C have ring-like portions 52, 53 constructed by winding edgewise the flat-type wire, and connection terminals 52a, 52b, 53a, 53b extended to the lateral side from the ring-like portions 52, 53 respectively. The connection terminals 52a, 53a are a leading terminal respectively. The connection terminal 52a is protruded to the terminal member 41 of the pedestal 34, and the connection terminal 53a is protruded to the terminal member 42. Also, the connection terminals 52b, 53b are middle-point terminals that are connected to each other, and are projected obliquely to the top end direction of the connection terminals 52a, 53a to aim at the terminal member 43 respectively.

Then, the primary winding 10p3, the spacer 33, the secondary winding 10s2, the spacer 32, the primary winding 10p2, the spacer 31, the secondary winding 10s1, the spacer 30, the primary winding 10p1, and the spacer 29 are stacked sequentially on the pedestal 34, and thus a coil portion 20C is constructed. This coil portion 20C is arranged between two cores 21, 22.

Then, the top end portions of one connection terminals 24a, 25a, 26a of the primary windings are overlapped with each other and are sandwiched between the connection end 45a of the terminal member 45 and the upper surface of the foot portion 40 of the pedestal 34. The top end portions of the other connection terminals 24b, 25b, 26b of the primary windings are overlapped with each other and are sandwiched between the connection end 44a of the terminal member 44 and the upper surface of the foot portion 39. Also, top ends of the connection terminals (middle-point terminals) 52b, 53b of the secondary windings are overlapped with each other and are sandwiched between the connection end 43a of the terminal member 43 and the upper surface of the foot portion 38. The top end portion of the connection terminal 52a of one secondary winding 10s1 is held between the connection end 41a of the terminal member 41 and the upper surface of the foot portion 36. The top end portion of the connection terminal 53a of the other secondary winding 10s2 is held between the connection end 42a of the terminal member 42 and the upper surface of the foot portion 37. Then, respective connection terminals of the above windings are finally connected to respective connection ends of the terminal members by the solder dip, etc.

According to the above configuration, the connection terminals 24a, 25a, 26a and the connection terminals 24b, 25b, 26b of the primary windings 10p1, 10p2, 10p3 are taken out to the leading terminal 44b and the leading terminal 45b, whose inter-terminal interval is narrow, respectively. Then, respective leading terminals of the transformer 10C are connected to the wiring conductors 49, 50, 51 of the circuit shown in FIG. 12. In other words, the leading terminal 44b out of the leading terminals 44b, 45b on the primary winding side is connected to the terminal portion 49c of the wiring conductor 49, and the leading terminal 45b is connected to the right end portion of the wiring conductor 50. Also, the leading terminal 41b out of the leading terminals 41b, 42b on the secondary winding side is connected to the terminal portion 49b of the wiring conductor 49, and the leading terminal 42b is connected to the left end portion of the wiring conductor 51.

As described above, if the arrangement shown in FIG. 12 and the transformer 10C according to the third embodiment are employed, respective parts in the DC-DC converter in the electric discharge lamp lightening circuit can be wired via the shortest paths.

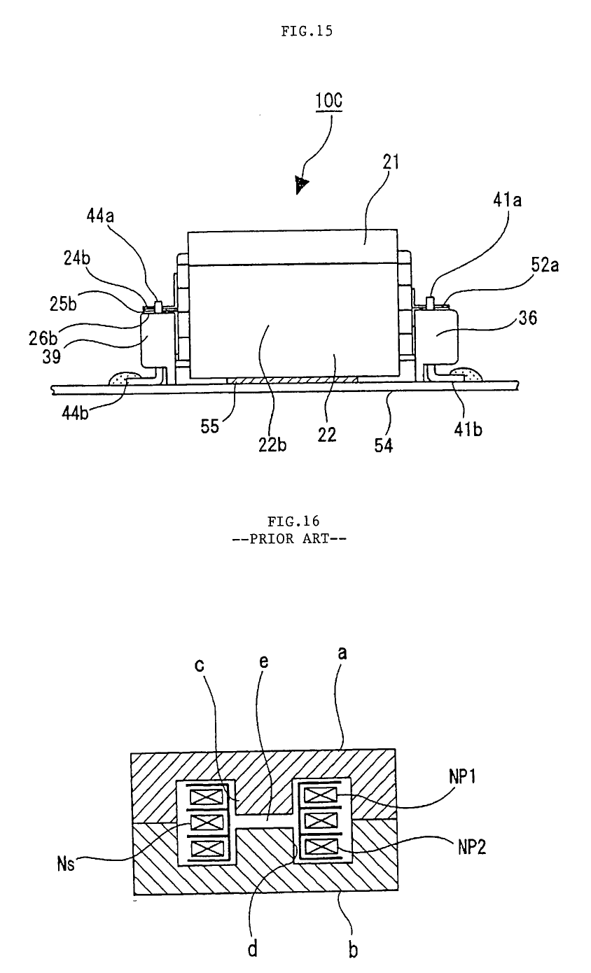

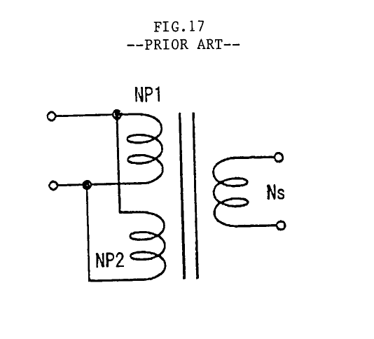

In this case, an adhesive 55 is interposed between the lower surface of the lower surface portion 22a of the lower core 22 in the transformer 10C and the printed board 54 on which the wiring conductors 47, 48, 49, 50, 51 are formed (see FIG. 15). The transformer 10C is secured to the printed board 54 with the adhesive 55.

In this case, all shapes and configurations of respective parts shown in above respective embodiments and the variation show merely an example of embodiments applied to embody the present invention. The technical scope of the present invention should never be interpreted limitedly by these shapes and configurations.

As apparent from the above description, the transformer of the present invention comprises a coil portion having a plurality of windings, and a plurality of cores arranged to sandwich the coil portion from aligning directions of the windings, and the windings includes ring-like portions formed by winding a flat-type wire like a ring to overlap each other; both end portions of the flat-type wire are led from the ring-like portions respectively; the plurality of windings and the plurality of cores are arranged along the overlapped direction of the flat-type wire; a projected portion is formed on a first core; the ring-like portions are positioned such that the ring-like portions are fitted on an outer side of the projected portion; a flat surface portion of a second core is positioned to oppose to the projected portion; a gap is formed between the flat surface portion and a top end portion of the projected portion, and the windings are positioned at positions except a position that surrounds the gap.

Therefore, in the transformer of the present invention, since the windings are not positioned at the position that surrounds the gap, the copper loss caused by the influence of the leakage magnetic flux around the gap can be eliminated and the electromagnetic coupling between the primary winding and the secondary winding can be improved.

In another aspect of the present invention, the inclined surfaces are formed on the top end portion of the projected portion so that a sectional area of the projected portion is set at the top end portion to be reduced gradually toward a top end surface. Therefore, such a DC-superposed characteristic is exhibited that the high primary inductance is shown up to a predetermined value of the primary current and then the primary inductance is reduced gently at the current value that is in excess of the predetermined value until the magnetic saturation is caused. As a result, the primary inductance required immediately after the starting of the electric discharge lamp and the large primary current can be assured.

Also, the core is formed by the molding using the mold up to the formation of the inclined surfaces, and then the flat surfaces used to constitute the gap are formed by the cutting. Therefore, the core having a predetermined shape can be manufactured at a low cost while maintaining a required precision.

According to another aspect of the present invention, a width between leading terminals of primary windings and a width between leading terminals of secondary windings are differentiated. Therefore, the leading terminals of the primary side and the secondary side can be discriminated with the naked eye, and thus the misunderstanding of the primary-side leading terminals and the secondary-side leading terminals at the time of assembling the transformer, the so-called failure assembling, can be prevented.

According to another aspect of the present invention, two outer leg portions that cover a part of the coil portion from an outer periphery side and are positioned on opposite sides to put the coil portion therebetween are provided to the first core, and mutually-opposing surfaces of two outer leg portions are formed straightly in parallel. Therefore, the connection terminals of the windings can be led in parallel with the outer leg portions, and thus design of the transformer can be facilitated.

What is claimed is:

1. A transformer, comprising a coil portion having a plurality of windings, and a plurality of cores arranged to sandwich the coil portion from aligning directions of the windings,
wherein the windings includes ring-like portions formed by winding a flat-type wire like a ring to overlap each other;
both end portions of the flat-type wire are led from the ring-like portions respectively;
the plurality of windings and the plurality of cores are arranged along the overlapped direction of the flat-type wire;
a projected portion is formed on a first core;
the ring-like portions are positioned such that the ring-like portions are fitted on an outer side of the projected portion;
a flat surface portion of a second core is positioned to oppose to the projected portion;
a gap is formed between the flat surface portion and a top end portion of the projected portion, and
the windings are positioned at positions except a position that surrounds the gap.

2. A transformer according to claim 1, wherein inclined surfaces are formed on the top end portion of the projected portion so that a sectional area of the projected portion is set at the top end portion to be reduced gradually toward a top end surface.

3. A transformer according to claim 1,
wherein the end portions form leading terminals of the windings, and
a width between leading terminals of primary windings and a width between leading terminals of secondary windings are differentiated.

4. A transformer according to claim 1,
wherein two outer leg portions, for covering a part of the coil portion from an outer periphery side, positioned mutually on opposite sides to put the coil portion therebetween, are provided to the first core, and
mutually-opposing surfaces of the two outer leg portions are formed straightly in parallel.
